(19) United States
(12) Patent Application Publication
(10) Pub. No.: US 2009/0166932 A1
(43) Pub. Date: Jul. 2, 2009

(54) Method for Manufacturing Seamless Silicon Roll Having Pattern and Seamless Silicon Roll Produced by the Same

(76) Inventors: Dong Wook Lee, Daejeon (KR); In Seok Hwang, Daejeon (KR); Sang Ki Chun, Daejeon (KR); Seung Wook Kim, Incheon (KR)

Correspondence Address: MCKENNA LONG & ALDRIDGE LLP, 1900 K STREET, NW, WASHINGTON, DC, 20006, US

(21) Appl. No.: 12/226,345

(22) PCT Filed: Oct. 25, 2007
(86) PCT No.: PCT/KR2007/005281

§ 371 Date: Oct. 16, 2008

(30) Foreign Application Priority Data
Oct. 27, 2006 (KR) 10-2006-010177
Nov. 10, 2006 (KR) 10-2006-0111060

(51) Int. Cl. B29C 35/08; B29C 71/00

(52) U.S. Cl. 264/483; 264/236; 264/494

(57) ABSTRACT

There is provided a seamless silicon roll having a pattern and a method of manufacturing the same. The method includes: preparing a pattern roll having the same size and pattern as a silicon roll to be manufactured; manufacturing a cast by pouring cast materials around the pattern roll and curing the cast materials; removing the cast from the pattern roll; forming a silicon roll by disposing the central axis of a roll in the cast, pouring liquid silicon and curing the liquid silicon; and removing the silicon roll from the cast.

### TECHNICAL FIELD

The present invention relates to a seamless silicon roll having a pattern and a method of manufacturing the same, and more particularly, to a seamless silicon roll having a pattern capable of easily printing a conductive material on an optical film and the like without regard to the area to be printed when the conductive material is printed to form a micro pattern of the conductive material on the optical film, and a method of manufacturing the same.

### BACKGROUND ART

Recently, various display devices such as televisions, computer monitors and the like have been manufactured in a flat panel display, such as LCD, PDP, etc., rather than a conventional cathode ray tube (CRT) mode. For many reasons, there are many occasions when a micro pattern of a conductive material is formed on a surface of the flat panel display. For example, in order to shield electromagnetic waves, a surface of a film may be coated with a conductive material in a network pattern, or a film having a stripe pattern is formed on a front substrate or a rear substrate of PDP.

To form this pattern on a film, it is necessary to coat the film with a conductive material. One of the methods used in the coating process comprises a photolithographic process. The photolithographic process is to form a desired pattern on a film by forming a conductive material on the entire surface of the film; applying a photosensitive material on the conductive material; exposing the photosensitive materials to the UV light (exposure) to correspond to a region to be removed or a remainder region, depending on the use of a negative or positive mode; removing the UV-exposed material or the remainder region (development); and etching a region from which the remainder region is removed.

The use of this photolithographic process is desirable since it is possible to form highly fine patterns, but the photolithographic process has disadvantages that it is complicated, the loss of expensive materials are high since the materials are applied to the other region other than a region to be patterned, and a lot of the cost is required to treat liquid waste generated during the development and etching processes. Also, when the exposure, development and etching equipment used in the photolithographic process is manufactured in a large scale, its manufacturing cost is also high, which is a big obstacle to catch up with a recent trend of large display screens.

Accordingly, printing processes that use inexpensive equipment and have low loss of conductive materials and no liquid waste have been increasingly in the limelight. Among them, the most widely used printing processes include a screen printing process, an off-set printing process, and a gravure printing process.

Among them, the screen printing process is a process of forming a pattern by putting a screen engraved with a desired printing pattern on each of films and applying a paste to the film using a roll, etc., but it has a problem that its productivity is extremely low since paste is printed on the films one by one.

The off-set printing process is a process of forming a pattern by applying a paste to a primary plate that is engraved with a certain pattern and made of glass or metals; filling a groove region of the pattern with the paste using a doctor blade; pressing a silicon roll (so-called a blanket) on the primary plate to primarily transfer the pattern to the silicon roll; and pressing the silicon roll on a substrate and rolling the silicon roll to secondarily transfer the primarily transferred pattern to the substrate.

However, the above-mentioned off-set printing process has an advantage that it is possible to print a fine pattern with a size of several ten micrometers (□) or less, but has a disadvantage that it is difficult to print a pattern with a thickness of 10 □ or more since the process time is long due to the two-step transfer process, and a paste filled in a primary plate is not completely transferred to a blanket.

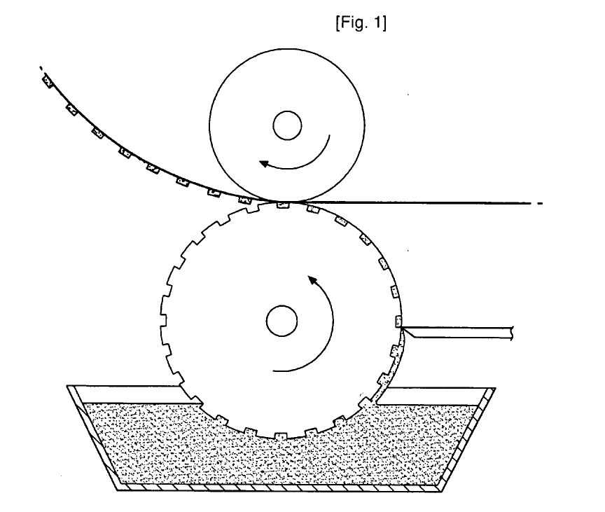

Accordingly, the most widely used process is the gravure printing process as shown in FIG. 1. The gravure printing is a process of dipping some of a printing roll engraved with a concave groove in a reservoir containing ink (a paste) as shown in FIG. 1, or soaking a surface of a roll with a paste using other methods (not shown), for example a method of supplying a paste onto a roll; removing the ink attached to a region other than the concave groove using a doctor blade while remaining the ink only in the concave groove; passing a film between a backup roll and the printing roll to transfer the paste in the concave groove of the printing roll to the film.

In the case of the gravure printing process, the printouts are possible even through a one-step transfer process, a roll-to-roll process is possibly used and it is possible to continuously form a desired pattern on a film, and therefore the gravure printing process is very effective to form a conductive pattern according to the present invention.

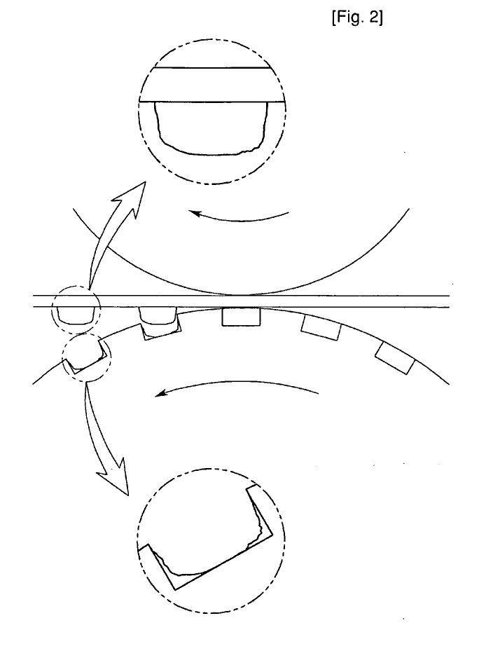

However, the gravure printing process has problems as follows. That is, a contact area between a roll and a film to be printed in a printing process is very small (theoretically, a contact area is seen as one point as viewed from its cross section since it forms a tangent line) since the roll used in the printing is made of hard materials, such as metals and the like, as shown in FIG. 2. As a result, a paste in a pattern groove formed in a surface of the roll is not completely transferred to a film, and some of the paste remains in the pattern groove, and therefore a desired pattern is incompletely transferred to a surface of the film corresponding to the pattern groove in which paste remains.

Therefore, a new printing method is introduced to solve the above problems. That is, the new printing method is designed to choose all of the above-mentioned advantages that the gravure printing process has, but to solve the above problems. This is a gravure printing process using a soft silicon roll in which the roll used in the gravure printing process is substituted with a soft silicon roll.

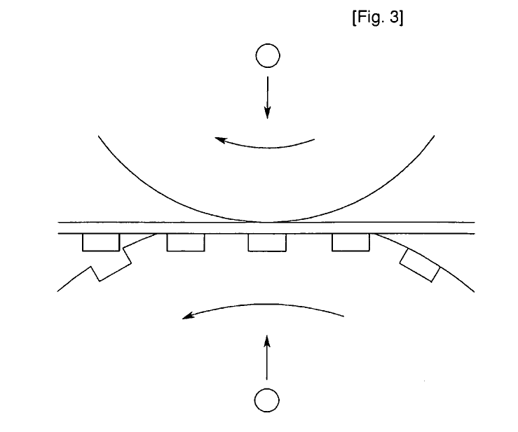

When a roll is made of soft silicon, a surface of the roll is deformed in a region in which the roll is in contact with the film if two facing roll axes are pressed against each other as shown in FIG. 3, which makes it possible for the roll to be in contact with a wider surface of the film. Also, since a sufficient pressure is applied to the pasts in the pattern groove, the paste may be transferred to the surface of the roll. As a result, the use of the gravure printing process using a soft silicon roll makes it possible to realize a thick pattern sufficiently.

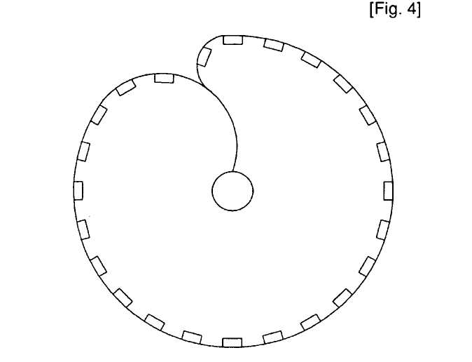

This soft silicon roll is produced by pouring liquid silicon into a glass master mold engraved with a reverse pattern, curing the liquid silicon to prepare a silicon pad and winding the silicon pad around a metal roll. However, when the soft silicon roll is produced according to the above process, the soft silicon roll is produced by winding the silicon pad as a material of the roll around the metal roll. Therefore, the soft silicon roll has seams formed inevitably therein since its both ends are not in concord with each other as shown in FIG. 4. As a result, the soft silicon roll has problems that it may be difficult to form a continuous pattern in a seam region when the gravure printing process is performed using the soft silicon roll.

Accordingly, when the gravure printing process is performed using the soft silicon roll, a desired pattern may be printed on a film having nearly the same length as one revolution of the roll, that is, a film whose length is shorter than the circumference of the roll.

However, the display devices have been manufactured with a large scale of 80 inches or more, but the display devices with a small size of 30 inches or less have also been manufactured in large numbers, but it was difficult to produce a film for display devices of all scales by using one kind of the above-mentioned roll. Accordingly, various kinds of rolls are cumbersomely provided in the display devices, and productivity is low since one printout is formed in only one revolution of a roll.

### DISCLOSURE OF INVENTION

### Technical Problem

An aspect of the present invention provides a method of manufacturing a seamless silicon roll having a pattern and a seamless silicon roll produced by the same.

Another aspect of the present invention provides a method for providing a silicon roll having a better surface equality in the manufacture of the silicon roll.

### Technical Solution

According to an aspect of the present invention, there is provided a method of manufacturing a seamless silicon roll having a pattern, including: preparing a pattern roll having the same size and pattern as a silicon roll to be manufactured; manufacturing a cast by pouring cast materials around the pattern roll and curing the cast materials; removing the cast from the pattern roll; forming a silicon roll by disposing the central axis of a roll in the cast, pouring liquid silicon and curing the liquid silicon; and removing the silicon roll from the cast.

Here, the cast materials may be selected from the group consisting of liquid- or gum-type silicon, liquid- or gum-type urethane and rubbers such as natural rubber, SBR, BR, CR, NBR and EPDM.

Also, the cast materials may include 0.1 to 10% by weight of a curing agent, based on the total weight of the cast materials.

Also, the cast material may be solvent-free.

In order to maintain a constant thickness of a cast, the manufacturing of the cast may include: installing molds around the pattern roll at a constant distance, pouring cast materials into a space between the molds and the pattern roll and curing the cast materials.

Also, the removing of the cast from the pattern roll may include: injecting air into a space between the pattern roll and the cast to reduce a contact area between the pattern roll and the cast and separating the cast from the pattern roll.

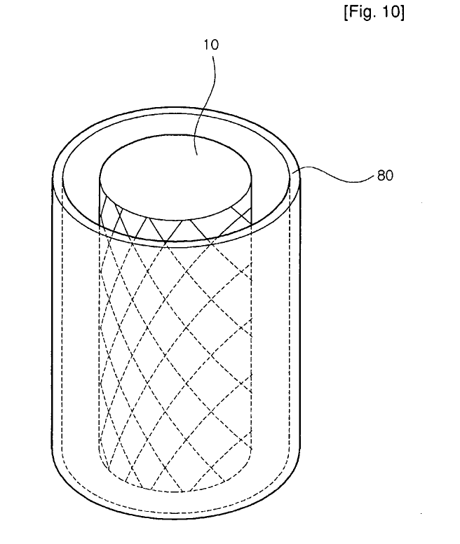

FIG. 10 is a diagram illustrating that a pattern roll is disposed inside molds to produce a cast of a constant thickness.

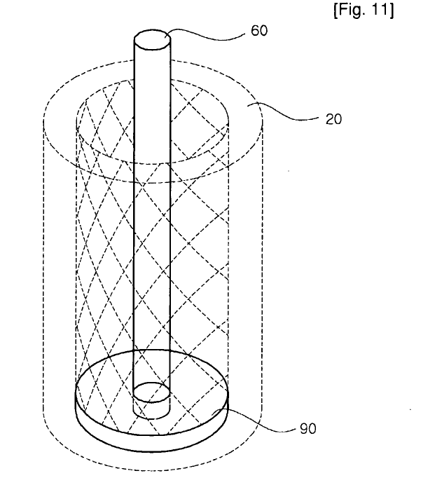

FIG. 11 is a schematic view illustrating that a frame is used to dispose a central axis exactly in the center of a roll.

### BEST MODE FOR CARRYING OUT THE INVENTION

Hereinafter, the present invention will be described in more detail with reference to the accompanying drawings.

The present inventors have found that it is not desirable to produce a silicon roll from a flat silicon pad as described in the art so as to produce a seamless silicon roll, but the seamless silicon roll is preferably produced by preparing a cast having the same shape as a silicon roll, injecting liquid silicon into the cast and curing the liquid silicon, and therefore the present invention was completed on the basis of the above facts.

That is, the method for manufacturing a silicon roll according to the present invention proceeds by installing the axis of a silicon roll in a cast in a correct location, injecting silicon, curing the silicon to produce a soft silicon roll and separating the soft silicon roll from the cast.

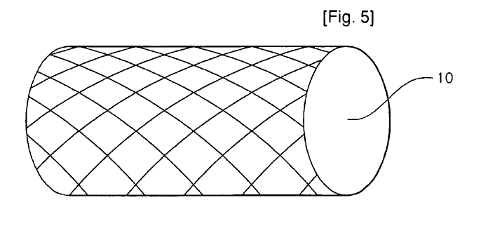

For this purpose, first, it is necessary to prepare a pattern roll 10 having the same shape as a silicon roll to be manufactured so as to produce a cast as shown in FIG. 5. A certain pattern is formed in a surface of the pattern roll 10 in the same manner as the silicon roll, and made of metal or glass considering its deformation and its frequent use.

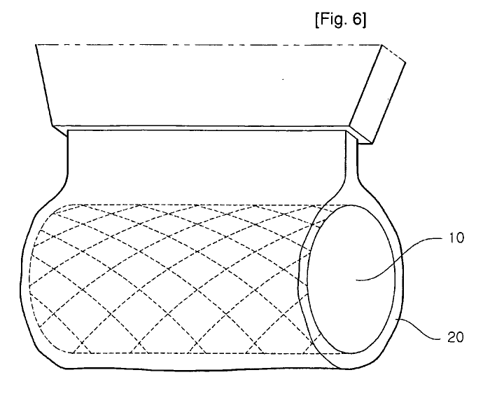

As shown later in FIG. 6, an operation of producing a cast is followed, including: pouring a cast material 20 around the pattern roll 10 and curing the cast material 20. Soft materials having excellent elasticity are necessarily used as the cast material to easily separate the cast material from a pattern roll without damages to the cast material, and liquid materials such as liquid silicon or liquid urethane are preferably used as a rubbery material, or gum-type silicon, gum-type urethane or conventional rubbers such as natural rubber, SBR, BR, CR, NBR and EPDM may also be used. However, if the above-mentioned cast materials are used to produce a cast, the shape of the cast may be deformed when the cast is separated from a metal roll as described later since the separation of the cast is performed by injecting the air into a space between the cast and the metal roll. However, the cast should be easily elastically recovered into a normal state since it is impossible to accurately control dimensions of a soft gravure roll to be produced if the cast is maintained in a deformed form after the separation of the cast. Therefore, the cast material preferably has elasticity. Also, a volume of the cast is desirably not changed before/after the curing of the cast because the cast should have the same dimensions as the pattern roll. Accordingly, the cast material is more preferably solvent-free. Also, a curing agent may be added in a small amount to cure the liquid cast material. Here, conventional curing agents that are used to cure liquid materials may be all used herein, and the present invention is not limited to the kind of the curing agents. Examples of the curing agent used in the silicon cast include Trigonox 101 (commercially available from Akzo Nobel, The Netherlands), but the present invention is not particularly limited thereto. The curing agent is preferably added in content of 0.1 to 10% by weight, based on the total weight of the above-mentioned cast materials such as liquid silicon or liquid urethane. When the content of the curing agent is too small, degree of cure of the cast materials is insufficient, whereas hardness of the prepared cast is extraordinarily high when the content of the curing agent is too high.

Because the cast material 20 has relatively high viscosity, it is possible to produce a cast by pouring down a cast material around a pattern roll. In order to produce a cast with a constant thickness, a cast may, however, be produced by disposing cylindrical molds 80 at a constant distance around a pattern roll 10 and filling a cast material as shown in FIG. 10. The cast prepared thus has an embossed pattern that is reverse to a pattern engraved in a surface of a silicon roll to be produced.

When the cast material is poured, there is no need to adjust temperature of the material, for example heating or cooling the material, but the temperature of the cast is preferably adjusted to approximately 150° C. when the cast material is poured or filled into the cast.

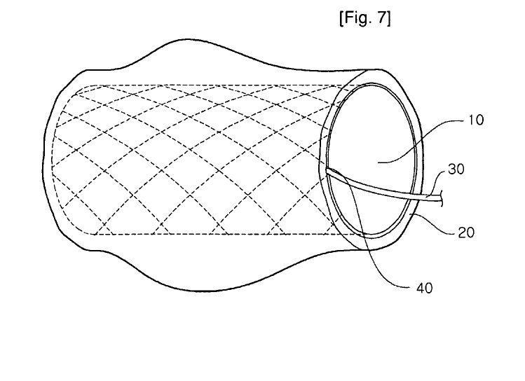

Subsequently, an operation of separating the cast 20 from the pattern roll is followed. FIG. 7 shows a process of removing a cast. As shown in FIG. 7, the cast 20 may be easily separated from the pattern roll 10 by injecting the air into a predetermined space 40 through an air injector pipe 30, the space 40 being ensured between the cast and the pattern roll.

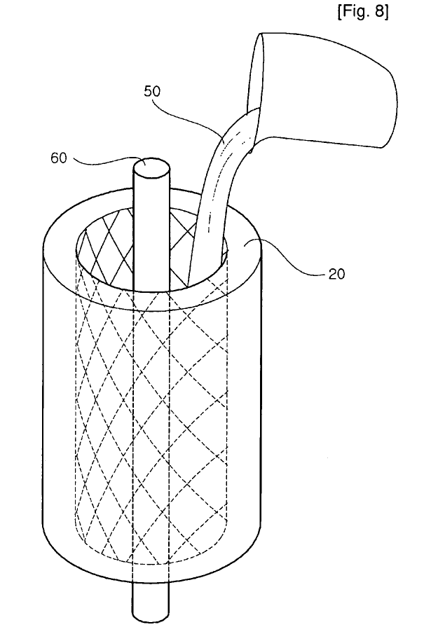

As shown in FIG. 8, the next operation is to form a silicon roll by pouring liquid silicon 50 into the cast 20 separated from the pattern roll 10 and curing the liquid silicon 50. In this case, silicon may be cured by keeping the silicon at room temperature for a certain period (particularly, about 24 hours; the given time is sufficient to cure the silicon, but the present invention is not particularly limited thereto). If the silicon is heated to higher temperature, the silicon is attached to the cast by reacting to a surface of the cast, and therefore the silicon is not undesirably separated from the cast. However, if the silicon is cured at room temperature, the silicon may be cured insufficiently. In this case, the resultant silicon roll may be further cured after the silicon roll is separated from the cast. Since the content of the curing agent used in the curing process may affect hardness of a silicon roll to be manufactured, it is preferred to adjust the content of the curing agent to a suitable content range. The curing agent is preferably added in a content of 3 to 30% by weight and more preferably 5 to 15% by weight, based on the total weight of the silicon. The curing agent is injected into the cast after it is previously mixed with the silicon.

One important point is to previously insert a silicon roll into a central axis 60 since the silicon roll is driven by the central axis 60. In this case, if the central axis is not precisely arranged in an exact location, the silicon roll applies different loads to the central axis while being rotated in the subsequent gravure printing process, which leads to the poor printing quality or the severe load in the central axis. Therefore, before the manufacture of a silicon roll, it is necessary to arrange a central axis in a location that is as exact as possible and inject a liquid silicon into a cast. Since the central axis is protruded out from both sides of the silicon roll, the central axis is more preferably disposed to form a groove in the bottom having the cast 20 formed therein and fit the central axis into the groove.

Also, in order to maintain the central axis in an exact location, it is more preferred to fit the cast 20 and the central axis 60 into a frame having a round frame 90 into which the cast 20 is previously fit and a hole for fitting the central axis 60 into the center of the round frame 90; inject liquid silicon; and cure the liquid silicon, as shown in FIG. 11.

Also, a volume of the silicon roll is preferably not changed before/after the curing of the silicon roll since the silicon roll has the same dimension as the cast. Therefore, the liquid silicon is more preferably solvent-free. Examples of the solvent-free liquid silicon include Sylgard 184 (commercially available from Dow Corning).

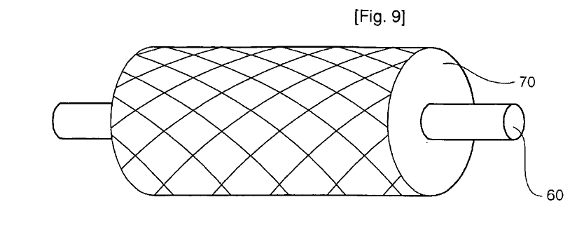

Then, the method of manufacturing the silicon roll according to the present invention is completed when the cast is separated from the silicon roll 70 (FIG. 9).

However, the soft silicon has a low interfacial energy, that is, a physical property that the soft silicon roll is not easily separated from the cast when the soft silicon roll is separated from the cast since the soft silicon roll and the cast has similar surface properties. If the interfacial energy between two materials is low, free surfaces are not easily formed when the two materials are separated from each other since an interfacial energy between the two materials is extremely lower than a surface energy caused by forming the free surface. In this case, the two materials tend not to form a new free surface. As a result, it is difficult to separate the two materials from each other. In the present invention, the soft silicon roll and the cast have physical properties that are similar to the two above-mentioned materials. Therefore, the silicon roll formed by injecting silicon and curing the silicon is not easily separated from the cast. Due to the close adhesion between the silicon roll and the cast, the silicon roll may also be separated from the cast with some of the silicon roll being attached to the cast, or the cast may be separated from the silicon roll with some of the cast being attached to the silicon roll when the silicon roll is forcefully separated from the cast.

In this case, printing quality may be deteriorated since a surface of the silicon roll is not smooth. The present inventors have ardently attempted to solve the above problems, and found that, when a surface of the cast is modified to produce the silicon roll, an interfacial energy between the cast and the silicon roll is increased since a cast and a silicon roll have different physical properties, which make it easy to separate the silicon roll from the cast. Therefore, the manufacturing method according to the present invention preferably further includes: surface-modifying an inner surface of the cast after an operation of removing the cast from the pattern roll, considering the above facts.

The surface-modification refers to a process for activating a surface of a cast to form a surface of the cast having different physical properties from a surface of a silicon roll so as to increase an interfacial energy between the cast and the silicon roll formed inside the cast, the surface of the cast becoming an interface that is in contact with the silicon roll formed in the subsequent operation of injecting a liquid silicon. The surface modification includes processes such as plasma treatment, UV-ozone treatment and corona discharge treatment. Among them, the plasma treatment is particularly effective to the surface activation of the cast. For the plasma treatment, all kinds of plasma that has been proposed herein may be used, including RF vacuum plasma, RF atmospheric pressure plasma, corona ambient pressure plasma or DBD ambient pressure plasma. However, the RF atmospheric pressure plasma is the most preferred, considering the easy handling in a large cast, the cost of equipment, etc.

Furthermore, among the cast materials, a silicon-based cast having a property of being easily separated from the pattern roll is generally used. When the silicon-based cast is used, it is difficult to separate a silicon roll from the cast since the silicon roll and the cast are made of substantially similar materials. Accordingly, the above-mentioned surface modification is more effective in the use of the silicon-based cast.

For the present invention, the plasma used for the surface modification of the cast includes plasma that is treated with any of plasma treatment methods, and for more particular examples with carrier gas such as Ar or He and reactive gas such as O₂, N₂, CF₄, etc. In this case, a flow rate of the carrier gas is preferably in a range of 50 to 300 sccm, and a flow rate of the reactive gas is preferably in a range of about 5 to 10 sccm. In this case, electric power used herein is, for example, a high frequency (RF) power of 13.56 MHz, and preferably in a range of about 50 to 3,000 Watt, and the cast is preferably exposed to the plasma for 5 to 30 seconds.

### Mode for the Invention

Hereinafter, exemplary embodiments of the present invention will be described in detail referring to the accompanying drawings. Therefore, the description proposed herein is just a preferable example for the purpose of illustrations only, not intended to limit the scope of the invention, so it should be understood that other equivalents and modifications could be made thereto without departing from the spirit and scope of the invention.

### EXAMPLES

### Example 1

A pattern roll made of stainless steel (SUS) was made by processing the SUS into a cylindrical shape a radius of 120 mm and a height of 600 mm, and X-type grooves whose surfaces will be filled with paste were formed with a width of 20 □, a depth of 20 □ and a distance of 300 □.

The curing agent, Trigonox 101 (from Akzo Nobel, The Netherlands), was mixed with the solvent-free silicon, Sylgard 184 (from Dow Corning), and the resulting mixture was applied to the exterior of the pattern roll, and then cured. The curing agent in the mixture was present in a content of 0.5% based on the total weight of the silicon, and the curing process was performed at 150° C. for 2 hours.

The cast and the pattern roll were separated from each other by injecting the air into a space between the cast and the pattern roll to reduce a contact area between the pattern roll and the cast.

The separated cast was fit into a frame, and a central axis with a radius of 80 mm and a height of 800 mm was fit into the center of the frame, as shown in FIG. 11. Then, a liquid silicon (Sylgard 184) was poured into the cast and cured. As the curing agent, a curing agent used exclusively for Sylgard 184 was added in a content of 10% by weight based on the total weight of the silicon.

Then, a silicon roll may be produced by removing the cast from the produced silicon roll. It was revealed that the produced silicon roll has a radius of 120 mm and a height of 600 mm that are identical to those of the pattern roll, and the central axis of the silicon roll was arranged in the center of the silicon roll.

Accordingly, it was seen that a seamless silicon roll can be produced according to the method of the present invention.

### Example 2

A pattern roll made of stainless steel (SUS) was made by processing the SUS into a cylindrical shape a radius of 120 mm and a height of 600 mm, and X-type grooves whose surfaces will be filled with paste were formed with a width of 20 □, a depth of 20 □ and a distance of 300 □.

The curing agent, Trigonox 101 (from Akzo Nobel, The Netherlands), was mixed with the solvent-free silicon, Sylgard 184 (from Dow Corning), and the resulting mixture was applied to the exterior of the pattern roll, and then cured. The curing agent in the mixture was present in a content of 0.5% based on the total weight of the silicon, and the curing process was performed at 150° C. for 2 hours.

The cast and the pattern roll were separated from each other by injecting the air into a space between the cast and the pattern roll to reduce a contact area between the pattern roll and the cast.

The cast separated from the pattern roll was surface-modified by supplying RF atmospheric pressure plasma to a surface of the separated cast. For the treatment of plasma, Ar gas having a flow rate of 200 sccm was used as the carrier gas, and O₂ having a flow rate of 10 sccm was used as the reactive gas. Also, an electric power was 100 W, a frequency was set to 13.56 MHz, and the plasma treatment was performed for 10 seconds.

The surface-modified cast was fit into a frame, and a central axis with a radius of 80 mm and a height of 800 mm was fit into the center of the frame, as shown in FIG. 11. Then, a liquid silicon (Sylgard 184) was poured into the cast and cured. As the curing agent, a curing agent used exclusively for Sylgard 184 was added in a content of 10% by weight based on the total weight of the silicon.

Then, a silicon roll may be produced by removing the cast from the produced silicon roll. The cast and the silicon roll may be separated from each other since they do not have a strong adhesion, and there was no residual cast material in a surface of the silicon roll and no dented traces other than a desired pattern in the surface of the silicon roll. It was revealed that the produced silicon roll has a radius of 120 mm and a height of 600 mm that are identical to those of the pattern roll, and the central axis of the silicon roll was arranged in the center of the silicon roll.

Also, it was revealed that there is no problem on the use of the seamless silicon roll since the seamless silicon roll prepared in Example 1 has a smooth surface when the cast is not treated with plasma as in Example 1, but the seamless silicon roll of Example 1 has slight surface defects in comparison with the seamless silicon roll prepared in Example 2 when the cast is treated with plasma as in Example 2, and therefore it is advantageous to treat a surface of the cast with plasma when the cast is treated with plasma as in Example 2, compared to when the cast is not treated with plasma as in Example 1.

Accordingly, it was seen that a seamless silicon roll having a smooth surface can be produced when the cast was surface-modified.

1. A method of manufacturing a seamless silicon roll having a pattern, the method comprising:
preparing a pattern roll having the same size and pattern as a silicon roll to be manufactured;
manufacturing a cast by pouring cast materials around the pattern roll and curing the cast materials;
removing the cast from the pattern roll;
forming a silicon roll by disposing the central axis of a roll in the cast, pouring liquid silicon and curing the liquid silicon; and
removing the silicon roll from the cast.

2. The method of claim 1, wherein the cast materials are selected from the group consisting of liquid- or gum-type silicon, liquid- or gum-type urethane and rubbers such as natural rubber, SBR, BR, CR, NBR and EPDM.

3. The method of claim 2, wherein the cast materials comprise 0.1 to 10% by weight of a curing agent, based on the total weight of the cast materials.

4. The method of claim 2, wherein the cast materials are solvent-free.

5. The method of claim 1, wherein the manufacturing of the cast comprises:
installing molds around the pattern roll at a constant distance, pouring cast materials into a space between the molds and the pattern roll and curing the cast materials.

6. The method of claim 1, wherein the removing of the cast from the pattern roll comprises: injecting air into a space between the pattern roll and the cast to reduce a contact area between the pattern roll and the cast and separating the cast from the pattern roll.

7. The method of claim 1, wherein the forming of the silicon roll comprises:
fitting a cast and central axis into a frame having a round frame into which the cast is fit and a hole for fitting a central axis into the center of the round frame; pouring liquid silicon; and curing the liquid silicon.

8. The method of claim 1, wherein the liquid silicon is solvent-free.

9. The method of claim 8, wherein the liquid silicon comprises 3 to 30% by weight of a curing agent, based on the total weight of the liquid silicon.

10. The method of claim 1, wherein a curing temperature of the liquid silicon is room temperature.

11. The method of claim 1, further comprising: surface-modifying an inner surface of the cast after the removing of the cast from the pattern roll.

12. The method of claim 11, wherein the surface modification is performed by at least one selected from the group consisting of plasma treatment, UV-ozone treatment and corona discharge treatment.

13. A silicon roll manufactured according to the method of claim 1, wherein the silicon roll has a seamless surface.

14. The method of claim 5, further comprising: surface-modifying an inner surface of the cast after the removing of the cast from the pattern roll.

15. The method of claim 6, further comprising: surface-modifying an inner surface of the cast after the removing of the cast from the pattern roll.

16. The method of claim 7, further comprising: surface-modifying an inner surface of the cast after the removing of the cast from the pattern roll.

17. The method of claim 14, wherein the surface modification is performed by at least one selected from the group consisting of plasma treatment, UV-ozone treatment and corona discharge treatment.

18. The method of claim 15, wherein the surface modification is performed by at least one selected from the group consisting of plasma treatment, UV-ozone treatment and corona discharge treatment.

19. The method of claim 16, wherein the surface modification is performed by at least one selected from the group consisting of plasma treatment, UV-ozone treatment and corona discharge treatment.
